(19) United States
(12) Patent Application Publication
(10) Pub. No.: US 2013/0152807 A1
(43) Pub. Date: Jun. 20, 2013

(54) TURNBAR AND TURNOVER MODULE FOR PRINTING SYSTEMS

(71) Applicants: Randy E. Armbruster, Rochester, NY (US); Thomas Niertit, Webster, NY (US); Christopher M. Muir, Rochester, NY (US); Bradley S. Bush, Hilton, NY (US); Bradley C. DeCook, Rochester, NY (US)

(72) Inventors: Randy E. Armbruster, Rochester, NY (US); Thomas Niertit, Webster, NY (US); Christopher M. Muir, Rochester, NY (US); Bradley S. Bush, Hilton, NY (US); Bradley C. DeCook, Rochester, NY (US)

(21) Appl. No.: 13/326,449

(22) Filed: Dec. 15, 2011

(51) Int. Cl. B41F 13/24

(52) U.S. Cl. 101/232

(57) ABSTRACT

A turnbar for use in a turnover module in a printing system includes one or more air-cushioned sections and one or more friction sections. Each air-cushioned section includes holes formed in a portion of a perimeter of the turnbar. Each friction section includes a friction-inducing material disposed over or affixed to another portion of the perimeter of the turnbar. Pressurized air or gas is output through the holes to produce a cushion of air or gas between a print media and the air-cushioned section. The turnbar can include one or more pistons within the turnbar, or one or more sleeves within or around the turnbar, or a combination of pistons and sleeves, to adjust airflow through the air-cushioned section.

### CROSS-REFERENCE TO RELATED APPLICATION

This patent application is related to U.S. patent application Ser. No. ______ (Docket K000764), entitled “METHOD FOR TRANSPORTING PRINT MEDIA” filed concurrently herewith.

### TECHNICAL FIELD

The present invention generally relates to printing systems and more particularly to a turnover module suitable for use in printing systems and methods for transporting the print media.

### BACKGROUND

Continuous web printing allows economical, high-speed, high-volume print reproduction. In this type of printing, a continuous web of print media, such as paper or other substrate material, is fed past one or more printing subsystems or modules that form images by applying one or more colorants onto the surface of the print media. When the print media is to be printed on both sides, a turnover module is included within or between two printing modules. The turnover module includes one or more stationary turnbars that typically have an ultra-high density polyethylene tape around the exterior surface of the turnbars to reduce the sliding friction of the print media as it wraps over a turnbar. The ultra-high density polyethylene tape reduces the friction of most types of print media but can increase web tension through the turnover module. When the web tension is sufficiently high, the print media can tear or break. Also, with certain types of print media, the turnbar friction can be high enough to cause the web tension to be greater than the drive capacity of the driven rollers. Transportation of the print media through the print system ceases when the web tension is higher than the drive capacity.

One technique used to reduce the web tension in the turnover module is the use of a cushion of air between the turnbar and the print media. Pressurized air or gas is introduced into the stationary turnbar to force the air or gas out of holes formed around the entire perimeter of the turnbar. The air forms a cushion at the area of contact between the print media and the turnbar such that the print media does not contact the surface of the turnbar. The air cushion, however, can cause web wander due to the print media “floating” around the entire turnbar. Web wander is undesirable because it reduces the accuracy of the print process and requires tracking of the print media to be re-established with the use of a web guide device or alternative method.

### SUMMARY

According to one aspect, a turnbar for use in a turnover module in a printing system includes one or more air-cushioned sections and one or more friction sections. Each air-cushioned section includes holes formed in a portion of a perimeter of the turnbar. Each friction section includes a friction-inducing material disposed over or affixed to another portion of the perimeter of the turnbar. Air or gas is output through the holes to produce a cushion of air or gas between a print media and the air-cushioned section.

According to another aspect, the turnbar can include one or more pistons disposed within the turnbar for adjusting airflow through at least one air-cushioned section. As an alternative to a piston, or in addition to the one or more pistons, a movable sleeve can be positioned either in the interior of, or over the exterior of, the turnbar to block the air holes of the turnbar and selectively control the size of one or more air-cushioned sections.

According to another aspect, a turnover module can include one or more turnbars, where one or more of the turnbars includes one or more air-cushioned sections, wherein each air cushioned section includes holes in a portion of a perimeter of the turnbar, and one or more friction sections each including a friction-inducing material disposed over another portion of the perimeter of the turnbar.

According to another aspect, at least one turnbar in the turnover module can include one or more pistons disposed within the turnbar for adjusting airflow through at least one air-cushioned section. As an alternative to a piston, or in addition to the one or more pistons, a movable sleeve can be positioned either in the interior of, or over the exterior of, the turnbar to block the air holes of the turnbar and selectively control the size of one or more air-cushioned sections.

According to another aspect, a method for transporting a print media over a turnbar in a turnover module in a printing system includes outputting air or gas through one or more air-cushioned sections in the turnbar, where each air cushioned section includes holes formed in a portion of a perimeter of the turnbar. The amount of the air or gas output from the air-cushioned section can be adjusted. For example, the amount of the air or gas output from the air-cushioned section can be adjusted based on one or more characteristics of the print media, including, but not limited to, the width or thickness of the print media.

### BRIEF DESCRIPTION OF THE DRAWINGS

Embodiments of the invention are better understood with reference to the following drawings. The elements of the drawings are not necessarily to scale relative to each other. Like numbers indicate like parts throughout the views.

FIG. 1 is a schematic side view of one example of a printing system in an embodiment in accordance with the present invention;

FIG. 2 illustrates a top perspective view of one example of a turnover assembly in an embodiment in accordance with the invention;

FIG. 3 is another top perspective view of the turnover module shown in FIG. 2;

FIG. 4 illustrates the path of the print media through turnover module 116 in an embodiment in accordance with the invention;

FIGS. 5 and 6 depict one example of a turnbar suitable for use in a turnover module in an embodiment in accordance with the invention;

FIG. 7 illustrates another example of a turnbar suitable for use in a turnover module in an embodiment in accordance with the invention; and

FIG. 8 is a flowchart of a method of transporting print media through a turnover assembly in an embodiment in accordance with the invention.

### DETAILED DESCRIPTION

The present description will be directed in particular to elements forming part of, or cooperating more directly with, apparatus in accordance with the present invention. It is to be understood that elements not specifically shown or described may take various forms well known to those skilled in the art.

In the context of the present disclosure, the term “continuous web of print media” relates to a print media that is in the form of a continuous strip of media as it passes through the printing system from an entrance to an exit thereof. The continuous web of print media itself serves as the receiving print medium to which one or more printing ink or inks or other coating liquids are applied in non-contact fashion. This is distinguished from various types of “continuous webs” or “belts” that are actually transport system components rather than receiving print media and that are typically used to transport a cut sheet medium in an electrophotographic or other printing system. The terms “upstream” and “downstream” are terms of art referring to relative positions along the transport path of a moving web; points on the web move from upstream to downstream.

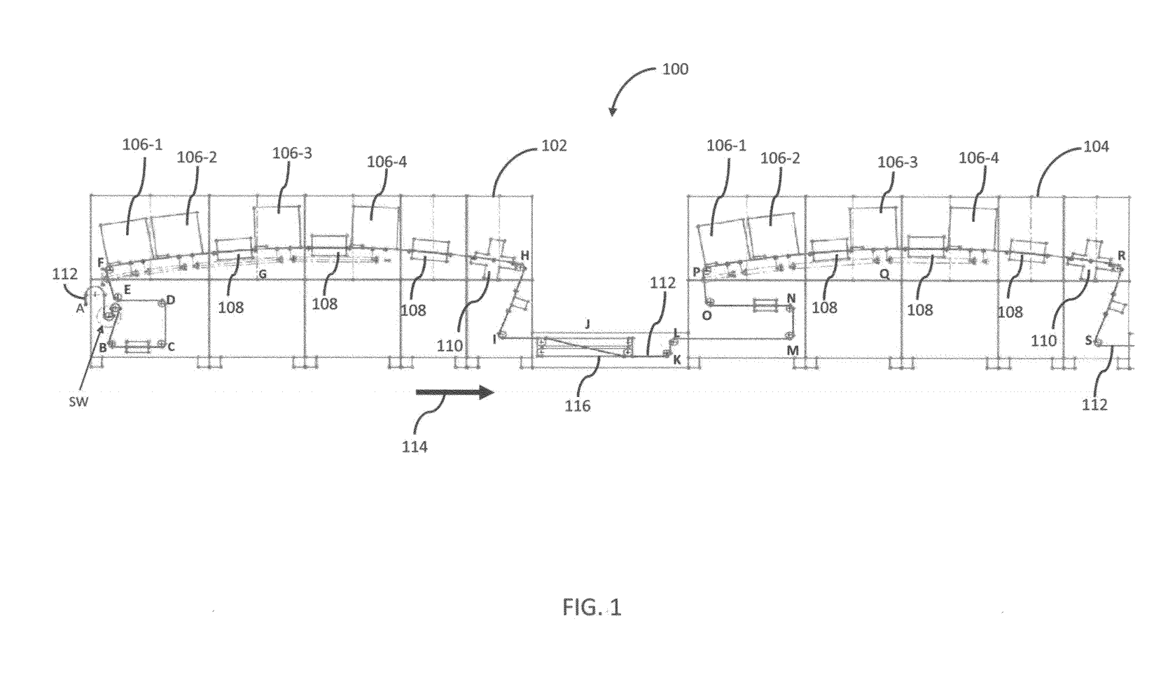

Referring now to the schematic side view of FIG. 1, there is shown one example of a printing system in an embodiment in accordance with the invention. Printing system 100 includes a first printing module 102 and a second printing module 104, each of which includes lineheads 106, dryers 108, and a quality control sensor 110. Each linehead 106 typically includes multiple printheads (not shown) that apply ink or another liquid to the surface of the continuous web of print media 112 that is adjacent to the printheads. For descriptive purposes only, the lineheads 106 are labeled a first linehead 106-1, a second linehead 106-2, a third linehead 106-3, and a fourth linehead 106-4. In the illustrated embodiment, each linehead 106-1, 106-2, 106-3, 106-4 applies a different colored ink to the surface of the print media 112 that is adjacent to the lineheads. By way of example only, linehead 106-1 applies cyan colored ink, linehead 106-2 magenta colored ink, linehead 106-3 yellow colored ink, and linehead 106-4 black colored ink.

The first printing module 102 and the second printing module 104 also include a web tension system that serves to physically move the print media 112 through the printing system 100 in the feed direction 114 (left to right as shown in the figure). The print media 112 enters the first printing module 102 from a source roll (not shown) and the linehead(s) 106 of the first module applies ink to one side of the print media 112. As the print media 112 feeds into the second printing module 104, a turnover module 116 is adapted to invert or turn over the print media 112 so that the linehead(s) 106 of the second printing module 104 can apply ink to the other side of the print media 112. The print media 112 then exits the second printing module 104 and is collected by a print media receiving unit (not shown).

First printing module 102 has a support structure that includes a cross-track positioning mechanism (A) for positioning the continuously moving web of print media in the cross-track direction, that is, orthogonal to the direction of travel and in the plane of travel. In one embodiment, cross-track positioning mechanism (A) is an edge guide for registering an edge of the moving media. A tensioning mechanism (SW), affixed to the support structure of first module 102, includes structure that sets the tension of the print media.

Downstream from the first printing module 102 along the path of the of print media 112, the second printing module 104 also has a support structure similar to the support structure for first printing module 102. Affixed to the support structure of either or both the first or second module is a kinematic connection mechanism that maintains the kinematic dynamics of the print media 112 in traveling from the first printing module 102 into the second printing module 104. Also affixed to the support structure of either the first or second module are one or more angular constraint structures for setting an angular trajectory of the print media 112.

Table 1 that follows identifies the lettered components used for print media transport as shown in FIG. 1. An edge guide in which the print media 112 is pushed laterally so that an edge of the media contacts a stop is provided at (A). The slack print media entering the edge guide allows the print media 112 to be shifted laterally without interference and without being over-constrained. An S-wrap device (SW) provides stationary curved surfaces over which the continuous print media 112 slides during transport. As the print media 112 is pulled over these surfaces, the friction of the print media 112 across these surfaces produces tension in the print media. In one embodiment, the S-wrap device (SW) is adapted to adjust the positional relationship between surfaces, to control the angle of wrap and to allow adjustments in the tension of the print media.

TABLE 1
Roller Listing for FIG. 1

| Media | |
|---|---|
| Handling | |
| Component | Type of Component |
| A | Lateral Constraint (edge guide) |
| SW | Tensioning Mechanism (S-wrap) |
| B | In-Feed Drive Roller |
| C | Castered and Gimbaled Roller |
| D | Gimbaled Load Cell |
| E | Servo-Castered and Gimbaled Roller |
| F | Fixed Roller (tach) |
| G | Rainbow Rollers (Qty = 17, 8 linehead, 6 dryer, 3 QC) |
| H | Servo-Castered and Gimbaled Roller |
| I | Gimbaled Roller |
| J | First Turnover Mechanism Drive |
| K | Second Turnover Mechanism Drive |
| L | Castered and Gimbaled Roller |
| M | Gimbaled Roller |
| N | Gimbaled Load Cell |
| O | Servo-Castered and Gimbaled Roller |
| P | Fixed Roller (tach) |
| Q | Rainbow Rollers (Qty = 17, 8 linehead, 6 dryer, 3 QC) |
| R | Servo-Castered and Gimbaled Roller |
| S | Out-Feed Drive Roller |

The first angular constraint is provided by in-feed drive roller B. This is a fixed roller that cooperates with a drive roller in the turnover module 116 and with an out-feed drive roller N in second printing module 104 in order to move the print media 112 through the printing system 100 with suitable tension in the feed direction 114. The tension provided by the preceding S-wrap serves to hold the print media 112 against the in-feed drive roll. Angular constraints at subsequent locations downstream along the print media 112 are provided by rollers that are gimbaled so as not to impose an angular constraint on the next downstream media span.

Although FIG. 1 depicts each printing module with four lineheads 106, three dryers 108, and one quality control sensor 110, embodiments in accordance with the invention are not limited to this construction. A printing system can include any number of lineheads, any number of dryers, and any number of quality control sensors. The printing system can also include a number of other components, including, but not limited to, web cleaners and web tension sensors.

And although the printing system shown in FIG. 1 has the turnover module 116 disposed between the first and second printing modules 102, 104, other printing systems can include the turnover module within one of the printing modules.

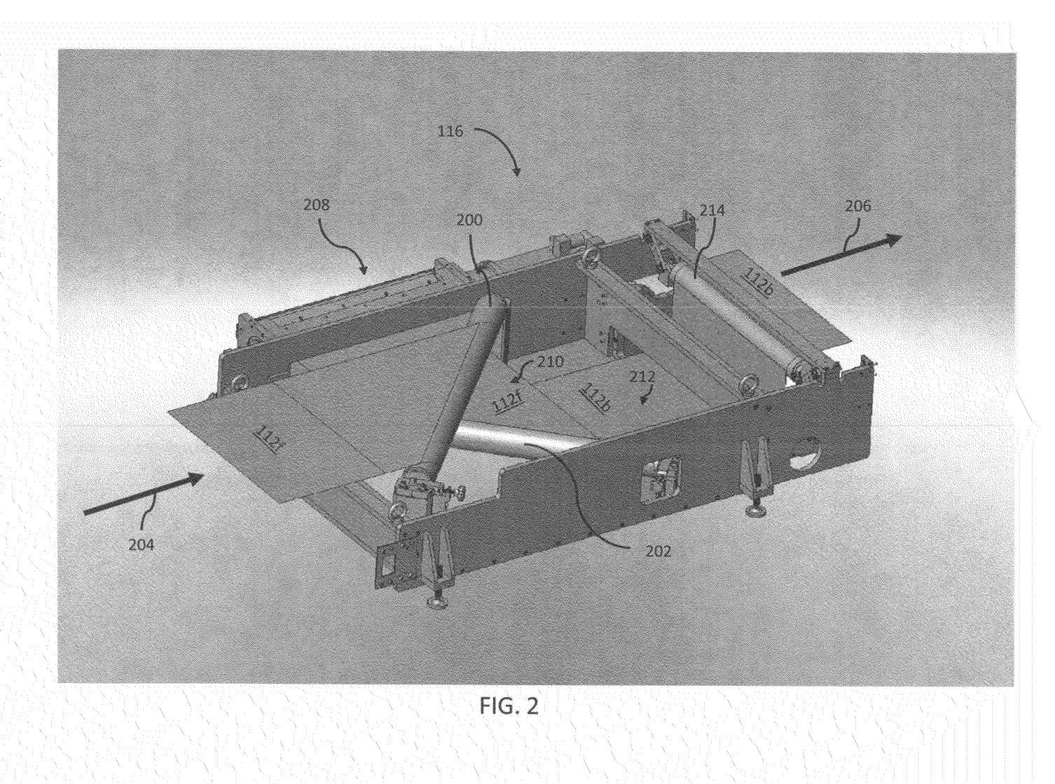

FIG. 2 illustrates a top perspective view of one example of a turnover module in an embodiment in accordance with the invention. Turnover module 116 includes stationary turnbars 200, 202 positioned at diagonals to the input path 204 and the output path 206. One or more turnbars can be included in other embodiments in accordance with the invention. For example, one turnbar can be included in a turnover module that also redirects the print media ninety degrees.

The print media 112 enters along the input path 204 with ink or another liquid jetted onto a front side of the print media 112. In FIGS. 2-4, the front side of the print media is identified as 112f and the back side of the print media as 112b.

The print media 112 then wraps around stationary turnbar 200 and passes to unit 208, where the print media wraps around a bar (not show) included in unit 208. The print media 112 exits unit 208 front side up, as shown in region 210. The print media 112 then wraps around stationary turnbar 202 and is directed along the output path 206. The print media 112 has now been inverted or turned over (see region 212) and the back side of print media 112b is positioned to receive ink from the linehead(s) in the next printing module (e.g., printing module 104 in FIG. 1). The print media 112 passes over bar 214 and exits the turnover module 116 along the output path 206.

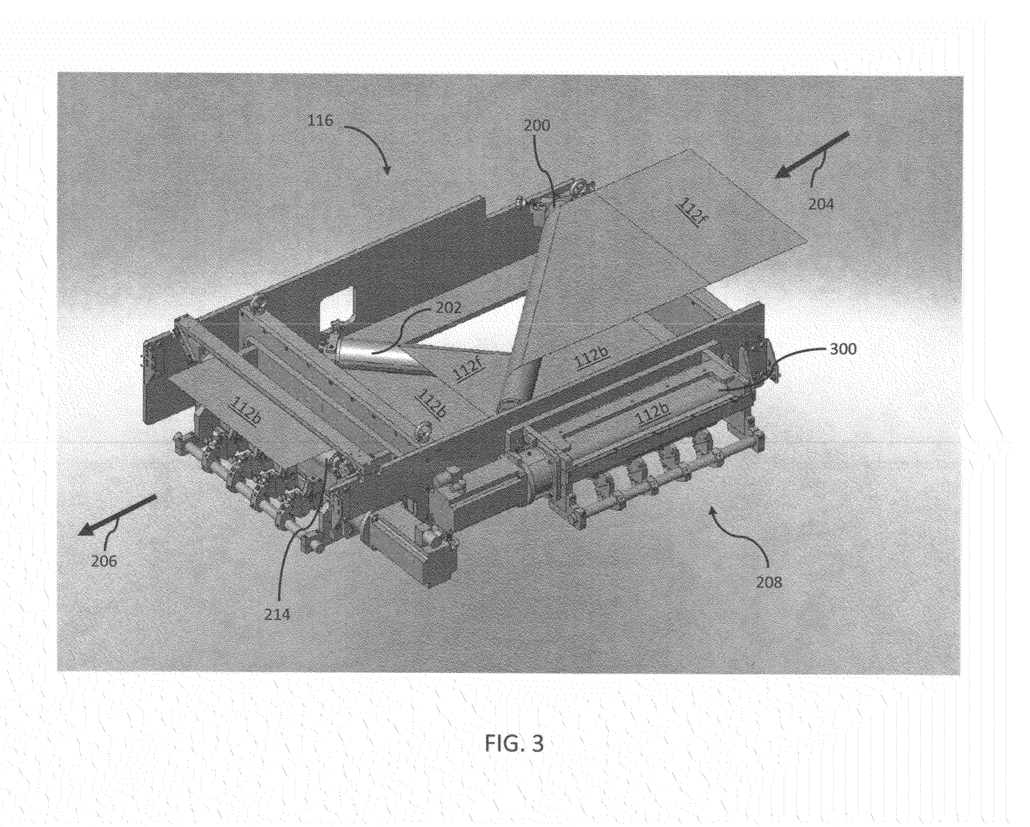

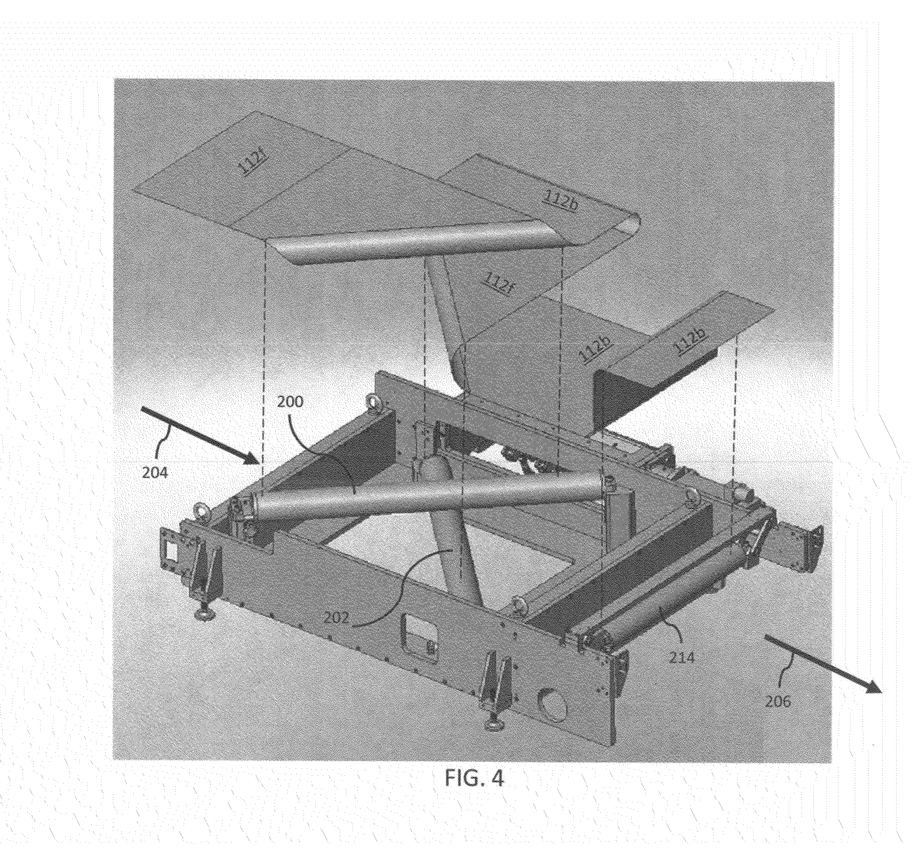

FIG. 3 is another top perspective view of the turnover module shown in FIG. 2. As discussed earlier, print media 112 wraps around stationary turnbar 200 and then wraps around bar 300 in unit 208. The print media 112 then wraps around stationary turnbar 202 and is directed along the output path 206. The print media 112 is inverted or turned over with the back side of print media 112b positioned to receive ink from the linehead(s) when the print media exits turnover module 116. FIG. 4 illustrates the path of the print media 112 through the turnover module 116 shown in FIGS. 2 and 3.

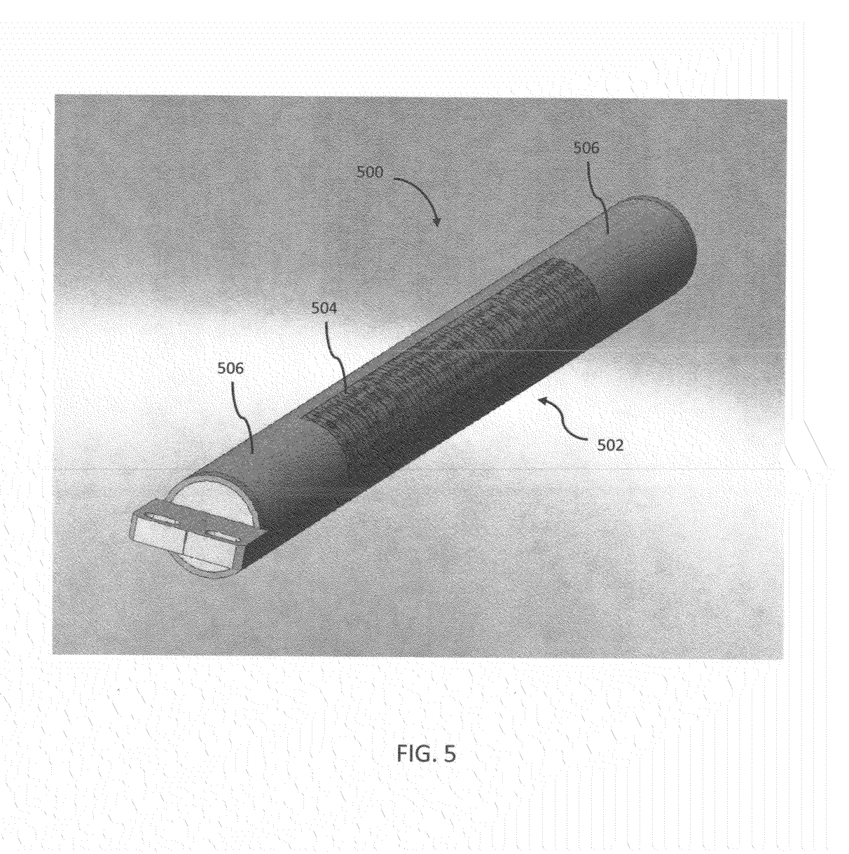

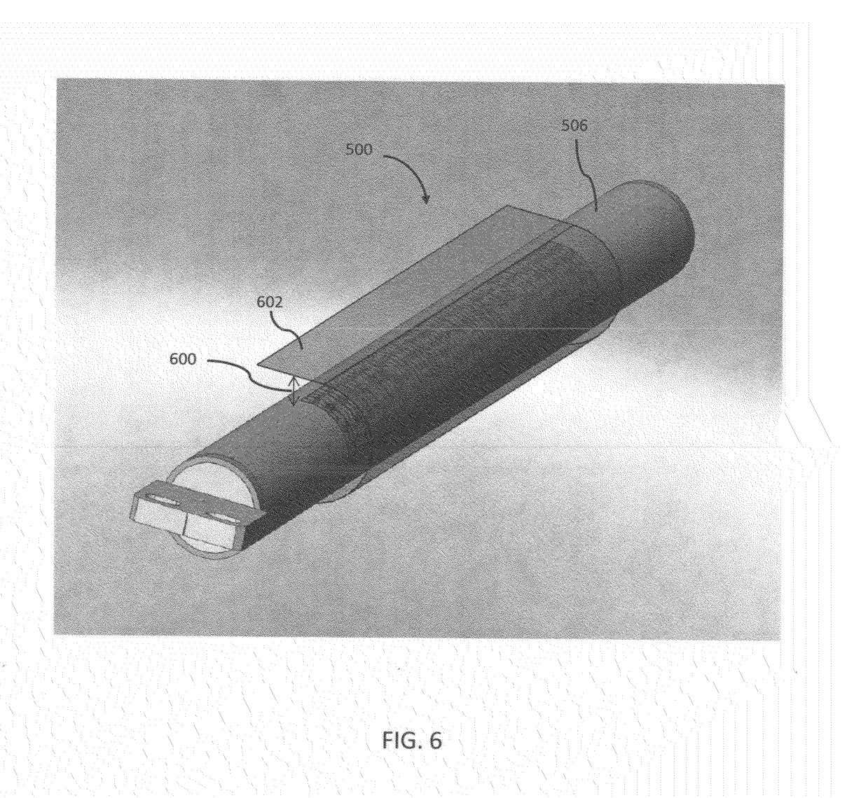

Referring now to FIGS. 5 and 6, there is shown one example of a turnbar suitable for use in a turnover module in an embodiment in accordance with the invention. Turnbar 500 can be used, for example, as stationary turnbars 200, 202 shown in FIGS. 2-4. Turnbar 500 includes an air-cushioned section 502 in a portion of the perimeter of turnbar 500. Air-cushioned section 502 includes holes 504 that are configured to allow pressurized air or a pressurized gas to pass through the holes and cause the print media to “float” over the air-cushioned section 502. The remaining portion of the perimeter of turnbar 500, identified herein as a friction section 506, does not include any holes. The friction section 506 includes a friction-inducing material affixed to or disposed over the entire friction section or a portion or portions of the friction section. The friction section 506 is used to maintain web stability.

Air-cushioned section 502 introduces a cushion of air or gas 600 (FIG. 6) between the air-cushioned section and the print media 602. The print media does not contact, or does not substantially contact, the turnbar in the air-cushioned section but does contact the turnbar in the friction section. The area of contact between the print media 602 and the friction section 506 produces a sufficient amount of friction that reduces web tension without inducing web wander.

Although FIGS. 5 and 6 illustrate only one air-cushioned section, other embodiments in accordance with the invention can include more than one air-cushioned section. The air-cushioned sections can be arranged in any given pattern on the perimeter of the turnbar. By way of example only, two strips of air-cushioned sections can extend across the entire width of a turnbar with friction sections formed between the air-cushioned sections.

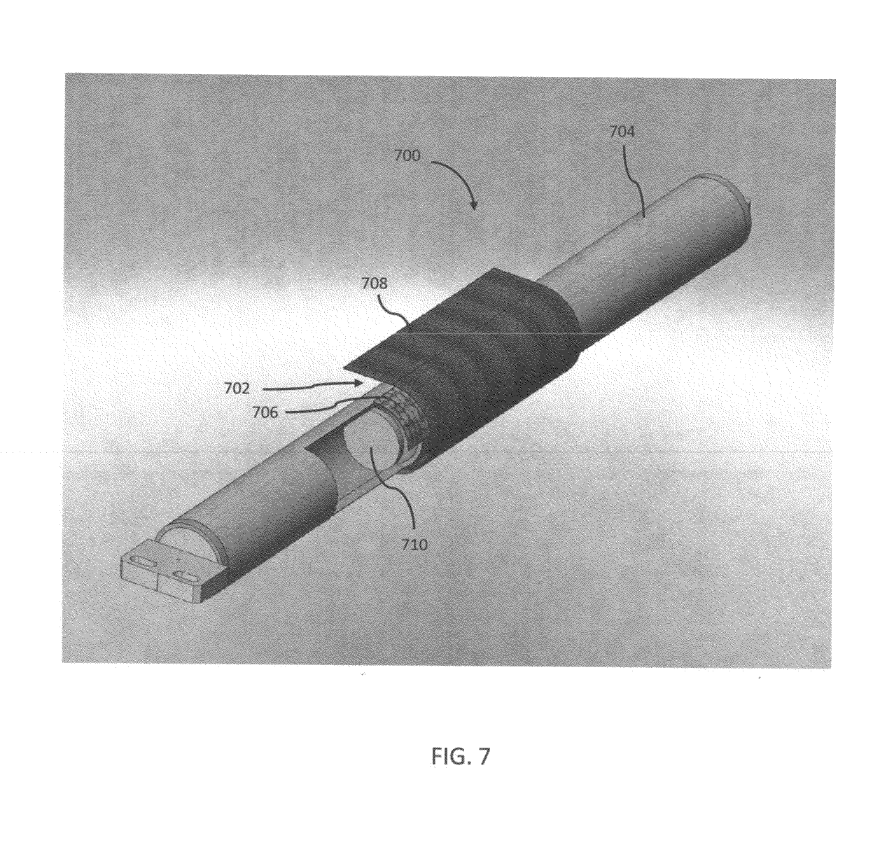

FIG. 7 depicts another example of a turnbar suitable for use in a turnover module in an embodiment in accordance with the invention. Turnbar 700 can be used, for example, as stationary turnbars 200, 202 shown in FIGS. 2-4. Turnbar 700 includes air-cushioned section 702 in a portion of the perimeter of turnbar 700. Friction section 704 is positioned adjacent to, or around, air-cushioned section 702. The holes 706 in air-cushioned section 702 are configured to allow pressurized air or a pressurized gas to pass through the holes and produce a cushion of air between the print media 708 and the air-cushioned section 702.

Included within lumbar 700 is piston 710. Piston 710 is adapted to slide back and forth within turnbar 700, allowing the size of air-cushioned section 702 to be variable and customized for different types of print media 708. Increasing or decreasing the size of air-cushioned section 702 changes the number of holes 706 that output pressurized air or gas, thereby increasing or decreasing the amount of air or gas output by air-cushioned section 702.

Although FIG. 7 illustrates only one air-cushioned section, other embodiments in accordance with the invention can include more than one air-cushioned section. Additionally, other embodiments in accordance with the invention can include any number of pistons. The area of an air-cushioned section can be divided into zones and the output of the air or gas from each zone controlled individually. Air-cushioned zones can be created by partitioning the internal area of the lumbar via airtight baffling with pneumatic regulators controlling airflow to each zone.

Moreover, as an alternative to a movable piston, or in addition to a movable piston, a movable sleeve can be positioned either in the interior of, or over the exterior of, the turnbar and used to block the air holes of the lumbar and selectively control the size of air-cushioned section 702. This allows the amount of air output from the air-cushioned section to be variable and customized for different types of print media.

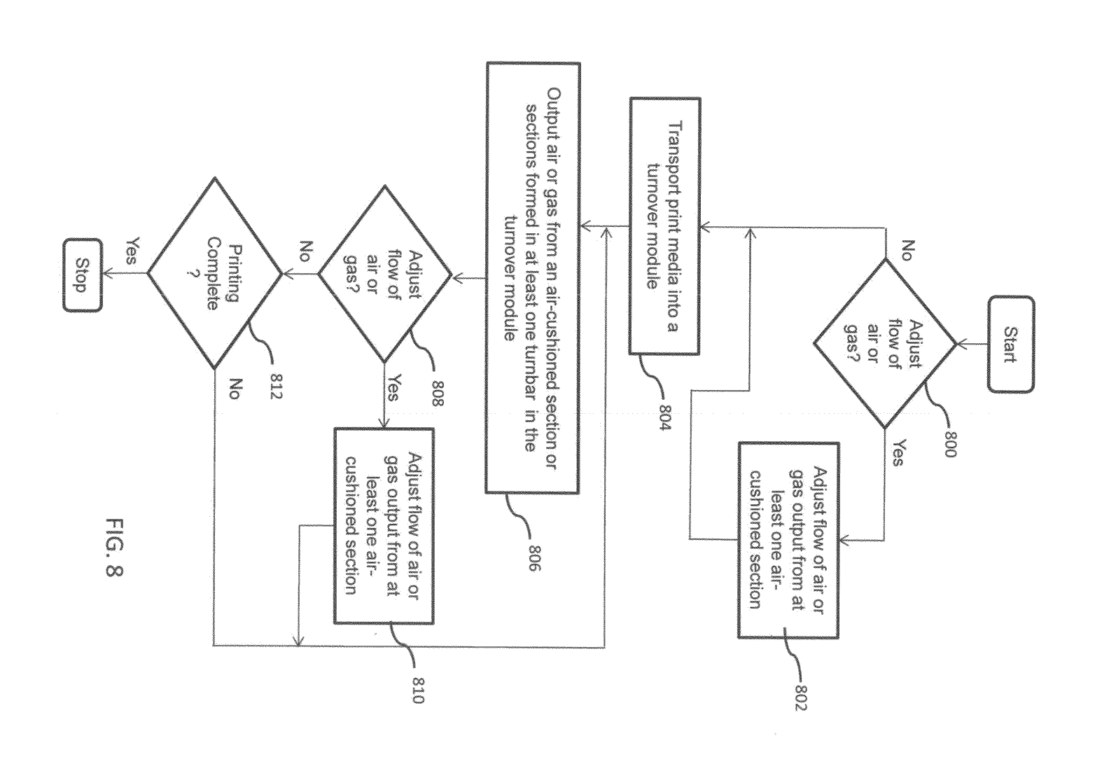

Referring now to FIG. 8, there is shown a flowchart of a method of transporting print media through a turnover assembly in an embodiment in accordance with the invention. A determination is made at block 800 as to whether or not the flow of air or gas is to be adjusted. Adjustment can be based on one or more factors, including, but not limited to, the characteristics of the print media being transported through the printing system. For example, the flow of air or gas can be optimized for a particular weight or width of the print media, the type of print media, or based on the frictional characteristics of the print media.

If the flow of air or gas is to be adjusted, the process passes to block 802 where the adjustment is made. Once the adjustment is complete, or if the flow of air or gas is not adjusted at block 800, the method passes to block 804 where the print media is transported into a turnover module in a printing system. As the print media passes through the turnover module, air or gas is output from one or more air-cushioned sections formed in at least one turnbar in the turnover module (block 806). The air or gas output from the air-cushioned section or sections causes the print media to float over the air-cushioned section or sections. The friction section or sections produces a sufficient amount of friction between the print media and the turnbar that maintains web stability without inducing web wander.

A determination is made at block 808 as to whether or not the flow of air or gas is to be adjusted. Block 806 provides continuous or intermittent monitoring of the flow of air or gas from the air-cushioned section or sections disposed in at least one turnbar in the turnover module. The flow of air or gas can be adjusted when needed during a print operation.

If the flow of air or gas is to be adjusted at block 808, the process passes to block 810 where the flow is adjusted. As discussed earlier, the adjustment can be based on one or more factors. The process then returns to block 806.

If the flow of air or gas is not to be adjusted at block 808, the method passes to block 812 where a determination is made as to whether or not the print operation is complete. If not, the process returns to block 806.

The blocks shown in FIG. 8 can be omitted or re-arranged in embodiments in accordance with the invention. And additional blocks can be included in the method. For example, block 806 or block 800 can be omitted. Block 804 can occur before block 800 in other embodiments in accordance with the invention.

The invention has been described in detail with particular reference to certain preferred embodiments thereof, but it will be understood that variations and modifications can be effected within the spirit and scope of the invention. And even though specific embodiments of the invention have been described herein, it should be noted that the application is not limited to these embodiments. In particular, any features described with respect to one embodiment may also be used in other embodiments, where compatible. The features of the different embodiments may be exchanged, where compatible.

1. A turnbar for use in a turnover module can include an air-cushioned section that includes holes formed in a portion of a perimeter of the turnbar, and a friction section that includes a friction-inducing material affixed to another portion of the perimeter of the turnbar. The friction section can be positioned adjacent to, or around, the air-cushioned section.
2. The lumbar in clause 1 can further include another air-cushioned section that includes holes formed in a different portion of the perimeter of the turnbar.
3. The turnbar as in clause 2, where an area of one air-cushioned section is different from an area of the other air-cushioned section.
4. The turnbar in any one of clauses 1-3 can further include at least one piston inside the turnbar for adjusting a size of one or more air-cushioned sections.
5. The turnbar in any one of clauses 1-3 can further include at least one movable sleeve for adjusting a size of one or more air-cushioned sections. The movable sleeve can be disposed in an interior of the turnbar or over the exterior of the turnbar.
6. The turnbar as in any one of clauses 1-5, where an area of one or more air-cushioned sections is divided into zones and the output of air or gas from each zone is controlled individually.
7. A turnover module can include one or more turnbars, where at least one of the one or more turnbars includes one or more air-cushioned sections and one or more friction sections. Each air cushioned section includes holes formed in a portion of a perimeter of the turnbar. Each friction section includes a friction-inducing material disposed over another portion of the perimeter of the turnbar.
8. The turnover module as in clause 7, where an area of one air-cushioned section is different from an area of another air-cushioned section.
9. The turnover module in clause 7 or clause 8 can further include at least one piston inside at least one of the one or more turnbars for adjusting a size of a respective air-cushioned section.
10. The turnover module in clause 7 or clause 8 can further include at least one movable sleeve for adjusting a size of one or more air-cushioned sections. The sleeve can be disposed in the interior of the turnbar or around the exterior of the turnbar.
11. The turnover module as in any one of clauses 6-10, where an area of the one or more air-cushioned sections is divided into zones and the output of gas or air from each zone is controlled individually.
12. A method for transporting a print media over a turnbar in a turnover module in a printing system includes outputting air or gas through holes formed in an air-cushioned section in the turnbar, where the air-cushioned section is formed in a portion of a perimeter of the turnbar, and adjusting a flow of air or gas output from air-cushioned section.
13. The method as in clause 12, where the flow of air or gas output from the air-cushioned section is adjusted based on one or more properties of the print media.
14. The method as in clause 12, where at least one property of the print media includes a width of the print media.
15. The method as in clause 13 or clause 14, where at least one property of the print media includes a thickness of the print media.

### PARTS LIST

100 printing system
102 printing module
104 printing module
106 linehead
108 dryer
110 quality control sensor
112 print media
114 feed direction
116 turnover module
200 turnbar
202 turnbar
204 input path
206 output path
208 unit
210 region
212 region
214 roller
300 roller
500 turnbar
502 air-cushioned section
504 holes
506 friction section
600 cushion of air
602 print media
700 turnbar
702 air-cushioned section
704 friction section
706 holes
708 print media
710 piston
800-808 blocks
A, B, C, D, E, F, G, H, I, J, K, L, M, N, O, P Rollers
SW S-wrap

1. A turnbar for use in a turnover module comprising:
an air-cushioned section that includes a plurality of holes in a portion of a perimeter of the turnbar; and
a friction section that includes a friction-inducing material affixed to another portion of the perimeter of the turnbar positioned adjacent to the air-cushioned section.

2. The turnbar as in claim 1, further comprising another air-cushioned section that includes a plurality of holes in a different portion of the perimeter of the turnbar.

3. The turnbar as in claim 2, wherein an area of one air-cushioned section is different from an area of the other air-cushioned section.

4. The turnbar as in claim 1, further comprising at least one piston inside the turnbar for adjusting an area of the air-cushioned section.

5. The turnbar as in claim 1, further comprising a movable sleeve for adjusting a size of the air-cushioned section.

6. The turnbar as in claim 2, further comprising at least one piston inside the turnbar for adjusting an area of at least one of the air-cushioned sections.

7. The turnbar as in claim 1, wherein an area of the air-cushioned section is divided into zones and each zone is controlled individually to output air.

8. The turnbar as in claim 2, wherein an area of at least one of the air-cushioned sections is divided into zones and each zone is controlled individually to output air.

9. A turnover module comprising:
one or more turnbars, wherein at least one of the one or more turnbars includes
one or more air-cushioned sections, wherein each air cushioned section includes holes in a portion of a perimeter of the turnbar; and
one or more friction sections each including a friction-inducing material disposed over another portion of the perimeter of the turnbar.

10. The turnover module as in claim 9, wherein an area of one air-cushioned section is different from an area of another air-cushioned section.

11. The turnover module as in claim 9, further comprising at least one piston inside the at least one turnbar for adjusting an area of one or more air-cushioned sections.

12. The turnover module as in claim 9, further comprising at least one movable sleeve for adjusting a size of one or more air-cushioned sections.

13. The turnover module as in claim 9, wherein an area of the one or more air-cushioned sections is divided into zones and each zone is controlled individually to output air.
